(19) United States
(12) Patent Application Publication
(10) Pub. No.: US 2022/0005462 A1
(43) Pub. Date: Jan. 6, 2022

(54) METHOD AND DEVICE FOR GENERATING OPTIMAL LANGUAGE MODEL USING BIG DATA

(71) Applicant: SYSTRAN INTERNATIONAL, Seoul (KR)

(72) Inventors: Myeongjin HWANG, Seoul (KR); Changjin JI, Seoul (KR)

(73) Assignee: SYSTRAN INTERNATIONAL, Seoul (KR)

(21) Appl. No.: 17/291,249

(22) PCT Filed: Nov. 5, 2018
(86) PCT No.: PCT/KR2018/013331

§ 371 Date: May 4, 2021

(51) Int. Cl. G10L 15/06; G10L 15/183

(52) U.S. Cl. CPC G10L 15/06; G10L 15/183

(57) ABSTRACT

An aspect of the present invention relates to a voice recognition method which may comprise the steps of: receiving a voice signal, and converting the voice signal into voice data; recognizing the voice data by using an initial voice recognition model, and generating an initial voice recognition result; searching for the initial voice recognition result in big data, and collecting data identical and/or similar to the initial voice recognition result; generating or updating a voice recognition model by using the collected identical and/or similar data; and re-recognizing the voice data by using the generated or updated voice recognition model, and generating a final voice recognition result.

### TECHNICAL FIELD

The present disclosure relates to a method for generating a language model with improved speech recognition accuracy and a device therefor.

### BACKGROUND ART

Automatic speech recognition technology is a technology of converting speech into text. In recent years, this technology has obtained a great improvement in recognition rate. Although the recognition rate has been improved, the speech recognizer still cannot recognize a word that is not in the dictionary of the speech recognizer. As a result, such a word is misrecognized as a wrong word. The only way to address this misrecognition issue so far is to include such vocabulary in the dictionary.

However, as new words/vocabularies are constantly being generated, this method will eventually lead to a degradation in speech recognition accuracy.

### DISCLOSURE

### Technical Problem

It is an object of the present disclosure to provide an efficient method for reflecting vocabularies that are constantly newly generated in a language model automatically/in real-time.

The objects to be achieved in the present disclosure are not limited to those mentioned above. Additional objects and features of the disclosure will be set forth in part in the description which follows and in part will become apparent to those having ordinary skill in the art upon examination of the following.

### Technical Solution

In accordance with one aspect of the present disclosure, a speech recognition method may include: receiving a speech signal and converting the speech signal into speech data; recognizing the speech data with an initial speech recognition model and generating an initial speech recognition result; retrieving the initial speech recognition result from big data and collecting data identical and/or similar to the initial speech recognition result; creating or updating a speech recognition model based on the collected identical and/or similar data; and re-recognizing the speech data with the created or updated speech recognition model and generating a final speech recognition result.

The collecting of the identical and/or similar data may include collecting data related to the speech data.

The related data may include a sentence or document including a word or character string of the speech recognition result or a similar pronunciation sequence, and/or data classified into the same category as the speech data in the big data.

The generating or updating of the speech recognition model may include generating or updating the speech recognition model using additionally defined secondary language data in addition to the collected identical and/or similar data.

In accordance with another aspect of the present disclosure, a speech recognition system may include: a speech input unit configured to receive a speech input; a memory configured to store data; and a processor configured to: receive a speech signal and convert the speech signal into speech data; recognize the speech data with an initial speech recognition model and generate an initial speech recognition result; retrieve the initial speech recognition result from big data and collect data identical and/or similar to the initial speech recognition result; create or update a speech recognition model based on the collected identical and/or similar data; and re-recognize the speech data with the created or updated speech recognition model and generate a final speech recognition result.

In collecting the identical and/or similar data, the processor may collect data related to the speech data.

The related data may include a sentence or document including a word or character string of the speech recognition result or a similar pronunciation sequence, and/or data classified into the same category as the speech data in the big data.

In generating or updating of the speech recognition model, the processor may generate or update the speech recognition model using additionally defined secondary language data in addition to the collected identical and/or similar data.

### Advantageous Effects

According to an embodiment of the present disclosure, misrecognition of a speech recognizer that may occur due to a new word/vocabulary that is not registered in the speech recognition system may be prevented.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the technical features of the present disclosure.

FIG. 1 is a block diagram of a speech recognition system according to an embodiment of the present disclosure.

FIG. 2 is a diagram illustrating a speech recognition system according to an embodiment.

FIG. 3 is a flowchart illustrating a speech recognition method according to an embodiment of the present disclosure.

### BEST MODE

Hereinafter, preferred embodiments of the present invention will be described in detail with reference to the accompanying drawings. The detailed description set forth below, in conjunction with the accompanying drawings, is intended to describe exemplary embodiments of the invention, and is not intended to represent the only embodiments in which the invention may be practiced. The following detailed description includes specific details to provide a thorough understanding of the present invention. However, one skilled in the art will appreciate that the present invention can be practiced without these specific details.

In some cases, in order to avoid obscuring the concept of the present disclosure, description of well-known structures and devices may be skipped, or block diagrams centered on the core functions of each structure and device may be illustrated.

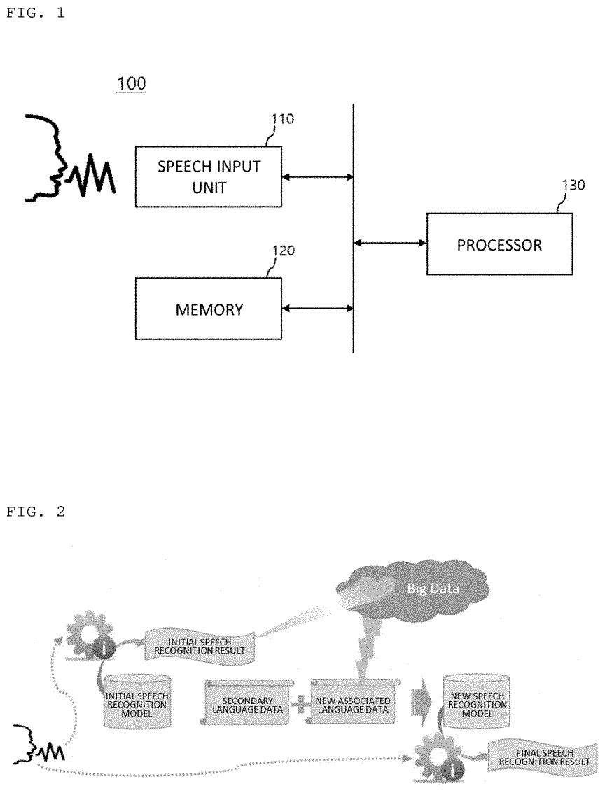

FIG. 1 is a block diagram of a speech recognition system according to an embodiment of the present disclosure.

Referring to FIG. 1, the speech recognition system 100 includes at least one of a speech input unit 110 configured to receive user speech, a memory 120 configured to store various data related to the recognized speech, and a processor 130 configured to process the input user speech.

The speech input unit 110 may include a microphone. When a user's uttered speech is input, the speech input unit converts the same into an electrical signal and outputs the signal to the processor 130.

The processor 130 may acquire user speech data by applying a speech recognition algorithm or a speech recognition engine to the signal received from the speech input unit 110.

The signal input to the processor 130 may be converted into a more useful form for speech recognition. The processor 130 may convert the input signal from an analog form to a digital form, and detect start and end points of the speech to detect an actual speech section/data included in the speech data. This operation is referred to as End Point Detection (EPD).

Then, the processor 130 may extract a feature vector of the signal within the detected section by applying feature vector extraction techniques such as cepstrum, linear predictive coding (or linear predictive coefficient (LPC)), Mel-frequency cepstral coefficients (MFCCs), or filter bank energy.

The processor 130 may store information about the end point of the speech data and the feature vector using the memory 120 configured to store data.

The memory 120 may include at least one storage medium among a flash memory, a hard disc, a memory card, a read-only memory (ROM), a random access memory (RAM), an electrically erasable programmable read-only memory (EEPROM), a programmable read-only memory (PROM), a magnetic memory, a magnetic disc, or an optical disc.

Further, the processor 130 may obtain a recognition result by comparing the extracted feature vector with a trained reference pattern. To this end, a speech recognition model for modeling and comparing signal characteristics of the speech and a language model for modeling a linguistic order relationship of words or syllables corresponding to the recognized vocabulary may be used.

The speech recognition model may be divided into a direct comparison method by which the recognition target is set as a feature vector model and is compared with the feature vector of the speech data, and a statistical method by which the feature vector of the recognition target is statistically processed.

The direct comparison method is a method of setting units such as words and phonemes, which are recognition targets, as a feature vector model and comparing input speech therewith for similarity. A representative example is vector quantization. According to the vector quantization, the feature vector of the input speech data is mapped to a codebook, which is a reference model, and encoded as a representative value. Thereby, the code values are compared with each other.

The statistical model method is a method of composing a unit of the recognition target as a state sequence and using the relationship between state sequences. The state sequence may be composed of a plurality of nodes. The method using the relationship between state sequences is divided into dynamic time warping (DTW), hidden Markov model (HMM), and a method using a neural network.

The DTW is a method of compensating for a difference on the time axis when compared to the reference model considering the dynamic characteristics of a speech, whose signal length varies with time even if the same person speaks the same pronunciation. The hidden Markov model is a recognition technique that assumes that speech is a Markov process with a state transition probability and an observation probability of a node (output symbol) in each state, and then estimates the state transition probability and the observation probability of the node through the training data, and calculates the probability of occurrence of the input voice from the estimated model.

The language model that models a linguistic sequence relationship of words or syllables may reduce acoustic ambiguity and reduce recognition errors by applying the sequence relationship between the units constituting a language to the units obtained from speech recognition. The language model includes a statistical language model and a model based on finite state automata (FSA). In the statistical language model, chain probabilities of words such as unigram, bigram, and trigram are used.

The processor 130 may use any of the above-described methods in recognizing speech. For example, a speech recognition model to which the hidden Markov model is applied may be used, or an N-best search that integrates a speech recognition model and a language model may be used. The N-best search may improve recognition performance by selecting up to N recognition result candidates using a speech recognition model and a language model, and then re-evaluating the ranking of the candidates.

The processor 130 may calculate a confidence score (or may be abbreviated as “confidence”) to secure the reliability of the recognition result.

The confidence score is a measure of how reliable the result of speech recognition is. It may be defined as a relative value for the probability that the speech is uttered from other phonemes or words with respect to a phoneme or word that is the recognized result. Accordingly, the confidence score may be expressed as a value between 0 and 1 or between 0 and 100. When the confidence score is greater than a preset threshold, the recognition result may be accepted. When the score is less than the threshold, the recognition result may be rejected.

The confidence score may also be obtained according to various conventional confidence score acquisition algorithms.

The processor 130 may be implemented in a computer-readable recording medium using software, hardware, or a combination thereof. According to hardware implementation, it may be implemented using at least one of electrical units such as application specif integrated circuits (ASICs), digital signal processors (DSPs), digital signal processing devices (DSPDs), programmable logic devices (PLDs), FPGAs (field programmable gate arrays), processors, microcontrollers, and microprocessors.

According to software implementation, the processor may be implemented together with a separate software module configured to perform at least one function or operation, and the software code may be implemented by a software application written in an appropriate programming language.

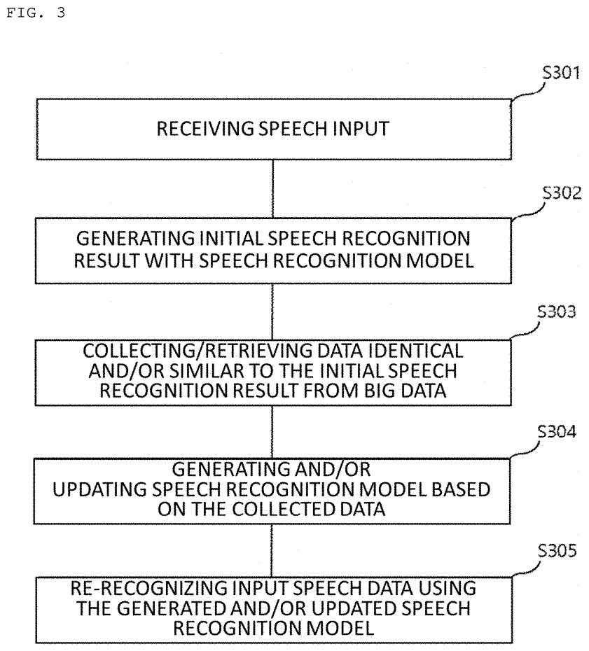

The processor 130 implements the functions, processes, and/or methods proposed in FIGS. 2 and 3, which will be described later. In the following description, the processor 130 is identified with the speech recognition system 100 for simplicity.

FIG. 2 is a diagram illustrating a speech recognition system according to an embodiment.

Referring to FIG. 2, the speech recognition system may generate an initial/sample speech recognition result by recognizing speech data with an (initial/sample) speech recognition model. Here, the (initial/sample) speech recognition model may be a speech recognition model pre-generated/pre-stored in the speech recognition system, or a secondary speech recognition model that is pre-generated/pre-stored separately from a main speech recognition model to recognize the initial/sample speech.

The speech recognition system may collect data identical/similar to the initial/sample speech recognition result (associated language data) from the big data. The speech recognition system may collect/retrieve not only the initial/sample speech recognition result but also other data related thereto (different data in the same/similar category) in collecting/retrieving the identical/similar data.

The above big data is not limited in format, and may be Internet data, a database, or a large amount of unstructured text.

In addition, there are no restrictions on the source and acquisition method of the big data. The big data may be obtained from a web search engine, obtained directly through a web crawler, or obtained from a pre-established local or remote database.

In addition, the similar data may be a document, paragraph, sentence, or partial sentence that is determined to be similar to the initial speech recognition result and extracted from the big data.

In addition, to determine the degree of similarity used in extracting the similar data, an appropriate method may be used according to the situation. For example, a similarity determination equation employing TF-IDF, information gain, cosine similarity, or the like may be used, or a clustering method employing k-means may be used.

The speech recognition system may generate a new speech recognition model (or update the pre-generated/pre-stored speech recognition model) using the collected language data and secondary language data. In this case, the auxiliary language data may not be used and only the collected language data may be used. The secondary language data used at this time is a collection of data that must be included in text data to be used for speech recognition training or data that are expected to be insufficient. For example, if a speech recognizer is to be used for address search in Gangnam-gu, the language data to be collected will be data related to addresses in Gangnam-gu, and the secondary language data will be ‘address’, ‘house number’, ‘tell me’, ‘report, ‘change’, or the like.

The speech recognition system may generate a final speech recognition result by re-recognizing the speech data received through the generated/updated speech recognition model.

FIG. 3 is a flowchart illustrating a speech recognition method according to an embodiment of the present disclosure. The above-described embodiments/descriptions may be identically/similarly applied in relation to this flowchart, and redundant description will be omitted.

First, the speech recognition system may receive a speech input from the user (S301). The speech recognition system may convert the input speech (or speech signal) into speech data and store the data.

Next, the speech recognition system may generate an initial speech recognition result by recognizing speech data with a speech recognition model (S302). The speech recognition model used herein may be a speech recognition model that is pre-generated/pre-stored in the speech recognition system, or may be a speech recognition model separately defined/generated to generate an initial speech recognition result.

Next, the speech recognition system may collect/retrieve data identical and/or similar to the initial speech recognition result from the big data (S303). In collecting/retrieving the identical/similar data, the speech recognition system may collect/retrieve not only an initial speech recognition result, but also various other language data related thereto. For example, as the related data, the speech recognition system may collect/retrieve a sentence or document including a word or string of the speech recognition result or a similar pronunciation string, and/or data classified into the same category as the input speech data in the big data.

Next, the speech recognition system may generate and/or update a speech recognition model based on the collected data (S304). More specifically, the speech recognition system may generate a new speech recognition model based on the collected data, or update a pre-generated/pre-stored speech recognition model. To this end, secondary language data may additionally be used.

Next, the speech recognition system may re-recognize the input speech data using the generated and/or updated speech recognition model (S305).

As the speech is recognized based on the speech recognition model generated/updated in real time, the probability of misrecognition of speech may be lowered and the accuracy of speech recognition may be increased.

Embodiments according to the present disclosure may be implemented by various means, for example, hardware, firmware, software, or a combination thereof. For implementation by hardware, one embodiment of the disclosure includes one or more application specific integrated circuits (ASICs), ital signal processors (DSPs), digital signal processing devices (DSPDs), programmable logic devices (PLDs), FPGAs (field programmable gate arrays), processors, controllers, microcontrollers, microprocessors, and the like.

For implementation by firmware or software, an embodiment of the present disclosure may be implemented in the form of a module, procedure, function, or the like that performs the functions or operations described above. Software code may be stored in the memory and driven by a processor. The memory is arranged inside or outside the processor, and may exchange data with the processor by various known means.

It will be apparent to those skilled in the art that the present disclosure may be embodied in other specific forms without departing from the essential features of the present disclosure. Therefore, the above detailed description should not be construed as limiting in all respects and should be considered illustrative. The scope of the disclosure should be determined by rational interpretation of the appended claims. Thus, it is intended that the present disclosure cover the modifications and variations of this disclosure provided they come within the scope of the appended claims and their equivalents.

### INDUSTRIAL APPLICABILITY

The present disclosure is applicable to various fields of speech recognition technology.

The present disclosure provides a method of automatically and immediately reflecting unregistered vocabulary.

Due to the features of the present disclosure disclosed above, misrecognition of unregistered vocabulary may be prevented. The technique related to misrecognition due to unregistered vocabulary may be applied to many speech recognition services where new vocabulary may occur.

1. A speech recognition method, comprising:
receiving a speech signal and converting the speech signal into speech data;
recognizing the speech data with an initial speech recognition model and generating an initial speech recognition result;
retrieving the initial speech recognition result from big data and collecting data identical and/or similar to the initial speech recognition result;
creating or updating a speech recognition model based on the collected identical and/or similar data; and
re-recognizing the speech data with the created or updated speech recognition model and generating a final speech recognition result.

2. The method of claim 1, wherein the collecting of the identical and/or similar data comprises:
collecting data related to the speech recognition. result.

3. The method of claim 2, wherein the related data includes a sentence or document including a word or character string of the speech recognition result or similar pronunciation sequence, and/or data classified into the same category as the speech data in the big data.

4. The method of claim 1, wherein the generating or updating of the speech recognition model comprises:
generating or updating the speech recognition model using additionally defined secondary language data in addition to the collected identical and/or similar data.

5. A speech recognition system, comprising:
a speech input unit configured to receive a speech input;
a memory configured to store data; and
a processor configured to:
receive a speech signal and convert the speech signal into speech data;
recognize the speech data with an initial speech recognition model and generate an initial speech recognition result;
retrieve the initial speech recognition result from big data and collect data identical and/or similar to the initial speech recognition result;
create or update a speech recognition model based on the collected identical and/or similar data; and
re-recognize the speech data with the created or updated speech recognition model and generate a final speech recognition result.

6. The speech recognition system of claim 5, wherein, in collecting the identical and/or similar data, the processor collects data related to the speech data.

7. The speech recognition system of claim 6, wherein the related data includes a sentence or document including a word or character string of the speech recognition result or a similar pronunciation sequence, and/or data classified into the same category as the speech data in the big data.

8. The speech recognition system of claim 5, wherein, in generating or updating of the speech recognition model, the processor generates or update the speech recognition model using additionally defined secondary language data in addition to the collected identical and/or similar data.
